(19) United States
(12) Patent Application Publication
(10) Pub. No.: US 2012/0161652 A1
(43) Pub. Date: Jun. 28, 2012

(54) LED ILLUMINATION APPARATUS

(75) Inventors: DER-HO CHI, Tu-Cheng (TW); YANG-JUI CHAO, Tu-Cheng (TW); ZHI-QIANG XIE, Shenzhen City (CN); JI-BAO FU, Shenzhen City (CN); MI TANG, Shenzhen City (CN); WEN-TAO WU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/183,453

(22) Filed: Jul. 15, 2011

(30) Foreign Application Priority Data
Dec. 24, 2010 (CN) 201010605336.2

(51) Int. Cl. H05B 37/02

(52) U.S. Cl. 315/192; 315/201

(57) ABSTRACT

A light emitting diode (LED) illumination apparatus includes an LED illumination circuit and a constant current drive circuit to provide constant current to the LED illumination circuit. The LED illumination circuit includes at least two lighting branches connected in parallel, and each of the at least two lighting branches includes at least one LED and a current regulative diode connected in series.

### BACKGROUND

1. Technical Field

The present disclosure relates to LED illumination apparatuses, and particularly, to an LED illumination apparatus with an LED illumination circuit thereof.

2. Description of the Related Art

An LED illumination apparatus commonly includes an LED series-parallel connection circuit with a number of LEDs, and a constant-current drive circuit for driving the LEDs using a constant current. However, characteristics of each LED are different from each other and may cause the current in each branch to be different. Furthermore, the constant-current drive circuit usually can maintain the stability of the current of the main circuit, but not for each branch. The current provided to each branch of the LED series-parallel connection circuit is not constant, which may decrease service life of the LEDs.

Therefore, there is room for improvement within the art.

### BRIEF DESCRIPTION OF THE DRAWINGS

The components in the drawings are not necessarily drawn to scale, the emphasis instead being placed upon clearly illustrating the principles of an LED illumination apparatus. Moreover, in the drawings, like reference numerals designate corresponding parts throughout the several views.

FIG. 1 is a block diagram of an LED illumination apparatus in accordance with an exemplary embodiment.

FIG. 2 is a circuit diagram of the LED illumination apparatus of FIG. 1 in accordance with an exemplary embodiment.

FIG. 3 is a circuit diagram of the LED illumination apparatus of FIG. 1 in accordance with another exemplary embodiment.

### DETAILED DESCRIPTION

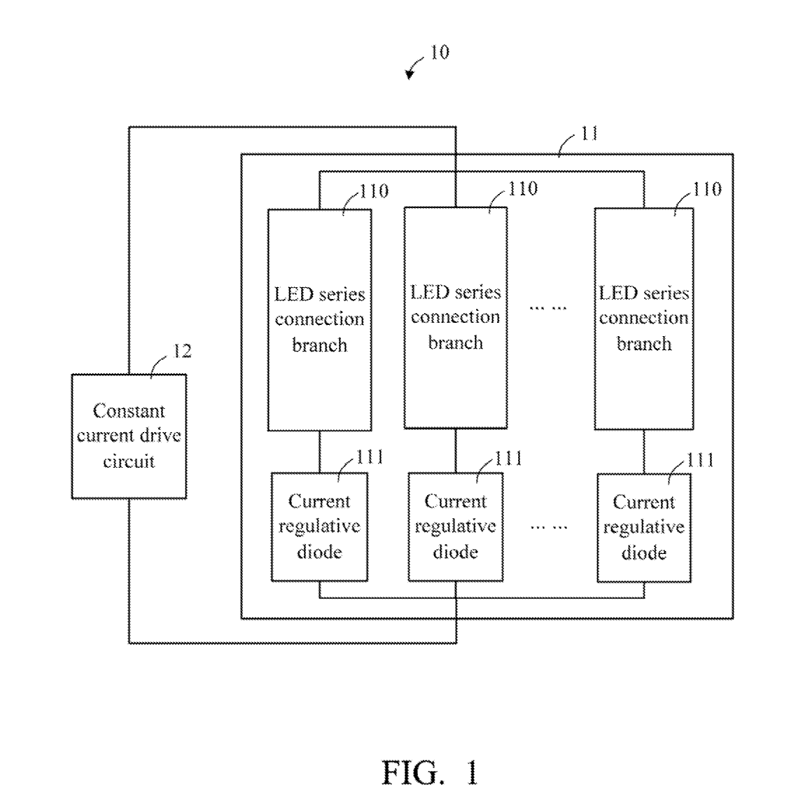

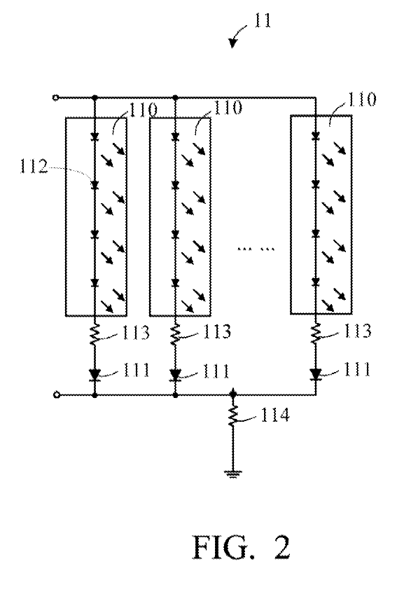

Referring to FIGS. 1 and 2, an LED illumination apparatus 10 includes an LED illumination circuit 11 and a constant current drive circuit 12 for driving the LED illumination circuit 11. The illumination LED circuit 11 includes at least two lighting branches 110; each of the lighting branches 110 includes a number of LEDs 112 and a current regulative diode 111 connected in series.

The LEDs 112 are connected in series. In the embodiment, the last LED 112 is connected to the anode of the current regulative diode 111 via a resistor 113. The cathodes of the current regulative diodes 111 are grounded via a resistor 114.

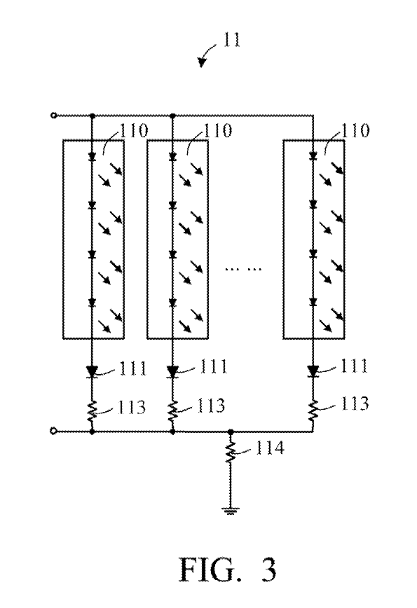

Referring to FIG. 3, in an alternative embodiment, in each lighting branch 110, the current regulative diodes 111 are connected between the last LED 112 and the resistor 113.

The current regulative diodes 111 are provided to maintain the current flowing therethrough being constant. When the current provided by the constant current drive circuit 12 changes, or one or some of the LEDs in either lighting branch 110 fail, which may cause the current of the LED series connection branch 110 to correspondingly vary; however, due to the constant current diode 111, the current of the corresponding branch 110 is maintained in constant. Thus, the currents of the LEDs of the LED series connection branch 110 are constant.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A light emitting diode (LED) illumination apparatus comprising:
an LED illumination circuit comprising:
at least two lighting branches connected in parallel, each of the at least two lighting branches comprising at least one LED and a current regulative diode connected in serials; and
a constant current drive circuit to provide constant current to the LED illumination circuit.

2. The LED illumination apparatus as recited in claim 1, wherein each of the at least two lighting branches further comprises a resistor, wherein the at least one LED is connected to an anode of the current regulative diode via the resistor.

3. The LED illumination apparatus as recited in claim 2, wherein the cathodes of the current regulative diodes are grounded via a resistor.

4. The LED illumination apparatus as recited in claim 1, wherein each of the at least two lighting branches further comprises a resistor, wherein an anode of the current regulative diodes is connected to the at least one LED, and a cathode of the current regulative diode is connected to the resistor.
